(19) United States
(12) Patent Application Publication
(10) Pub. No.: US 2003/0058816 A1
(43) Pub. Date: Mar. 27, 2003

(54) Forwarding communication network and wireless channel allocation method therefor

(76) Inventor: Daniel D. M. Shearer III, Scottsdale, AZ (US)

Correspondence Address: LOWELL W. GRESHAM, ESQ., MESCHKOW & GRESHAM, P.L.C., Suite 409, 5727 North Seventh Street, Phoenix, AZ, 85014, US

(21) Appl. No.: 10/006,631

(22) Filed: Dec. 4, 2001

Related U.S. Application Data
(60) Provisional application No. 60/324,501, filed on Sep. 24, 2001.

(51) Int. Cl. H04L 12/50; H04Q 7/00

(52) U.S. Cl. 370/329; 370/386

(57) ABSTRACT

A communication network (20) for providing communication throughout a region (90) is provided. The network (20) includes a hub access-point (HAP) device (40) coupled to a parent network (70) and configured to engage in connectionless outward communication (110) over a first wireless channel. The network (20) includes a plurality of forwarding access-point (FAP) devices (50), wherein one FAP device (50) is configured to engage in connectionless inward communication (120) with the HAP device (40) over the first wireless channel and to engage in connectionless outward communication (110) over a second wireless channel. The network (20) includes a plurality of customer-premise-equipment (CPE) devices (60), wherein one CPE device (60) is configured to engage in connectionless inward communication (120) with either the one FAP device (50) over the second wireless channel.

### RELATED INVENTION

The present invention claims priority under 35 U.S.C. §119(e) to: “Multihop Cellular Frequency Plan,” Provisional U.S. Patent Application Serial No. 60/324,501, filed Sep. 24, 2001, which is incorporated by reference herein.

The present invention is related to the U.S. patent application entitled “Multihop, Multi-Channel, Wireless Communication Network With Scheduled Time Slots,” Attorney Docket No. 2277-060, Ser. No. ______, by the inventor hereof and filed on even date herewith, which is incorporated by reference herein.

### TECHNICAL FIELD OF THE INVENTION

The present invention relates to the field of communication networks. More specifically, the present invention relates to the field of connectionless communication networks having allocated wireless channels.

### BACKGROUND OF THE INVENTION

It has long been feasible for computers and related devices to communicate with each other via a network. When a network is inter-agency, especially a network over a large geographical area, it is generally classed as a wide-area network (WAN). The Internet, a global network connecting of millions of computers, is a WAN.

When a network is constrained in use or geography, it is generally classed as a local-area network (LAN). For example, a corporation may use a LAN in each of its branches to independently interconnect that branch's computers. This allows the computers in each branch to share common branch data.

The server in each branch's LAN may then be a component of a WAN configured to serve the corporation as a whole. This arrangement allows the corporate-wide sharing of data. The WAN serves as a parent network with each branch's LAN serving as a daughter network. This arrangement allows the sharing of corporate-wide data.

Traditionally, a LAN has been implemented using a protocol requiring a physical medium to interconnect the components. A typical LAN, for example, might use a coaxial or other cable to effect the Institute of Electrical and Electronics Engineers, Inc., (IEEE) 802.3 protocol, also known as the Ethernet™ protocol.

It is no longer necessary for a LAN to have a physical interconnection medium. Recent advances in wireless technology have enabled the development of a wireless local-area network (WLAN). A WLAN may serve any of the functions of a traditional “hardwired” LAN forgoing the use of a physical interface medium. This allows a WLAN to be used where a hardwired LAN is impractical or undesired.

A WLAN uses the electromagnetic spectrum rather than wires to communicate between nodes. A WLAN may use an optical or a radio wireless interface medium. Each wireless interface medium has its strengths and weaknesses, with a radio interface medium being perhaps the most universal.

An optical WLAN (i.e., a WLAN using an optical interface medium) communicates via light, i.e., electromagnetic waves having wavelengths shorter than approximately 1 mm, typically infrared light. While an optical “transmitter” or “receiver” may be omnidirectional, efficient transmission and reception dictates, in the current state of the art, that the light be collimated into beams. This is most often done by using lasers as optical transmitters. The light beams cannot readily pass through optically opaque barriers (walls, etc.) nor bend around corners. An optical WLAN is therefore typically limited to a network having line-of-sight connected nodes.

A radio WLAN (i.e., a WLAN using a radio interface medium) communicates via radio waves, i.e., electromagnetic waves having wavelengths longer than approximately 1 mm. A radio transmitter or receiver may be either directional or omnidirectional for efficient transmission and reception. Dependent upon the actual frequencies used, the radio waves may readily pass through optically opaque barriers and may, at least to some extent, bend around corners. A radio WLAN is therefore not limited to a network having line-of-sight connected nodes.

Any WLAN in the remainder of this discussion is assumed to be a radio WLAN.

Any form of data may be passed over a WLAN. Cellular telephony, for example, is made up of a large number of interconnected WLANs, each of which is coupled to a WAN, the wired telephone network. With cellular telephony, a connection is made and maintained for the duration of a session (i.e., for the duration of the telephone call), whether or not information is being transferred. In this “connected” communication, dead time exceeds active time, i.e., the time of no data transmission exceed the time of data transmission.

Connected communications pose a problem in that, while a connection exists, that channel is tied up and other communications cannot take place. A connected WLAN therefore requires a large number of access points or hubs to operate efficiently. This problem is demonstrated by the cellular telephony system where many cell hubs, each handling a large number of channels, are required to maintain the connections over the system.

Connectionless communication systems do away with the session-long connection or circuit. In a connectionless communication, resources are dynamically taken for the duration of each data packet. A “session” may consist of thousands of data packets, each with its own allocation of resources. One example of connectionless communication is the aforementioned Ethernet protocol. In Ethernet, the (wired) communication link idles until a device wishes to transmit a data packet to another device. At that time resources are negotiated, if necessary, the data packet is transmitted, and the resources are then available to others. Since the dead time far exceeds the active time for most bidirectional sessions, the link is free to accept communications from other devices between the packet transmissions. This results in an efficient use of the communications link. This is especially true when data buffering is used. Such connectionless communications, however, can have considerable latency. This latency often makes connectionless communications less desirable for telephony applications.

A WLAN, being a local-area network, is normally limited in physical area. A typical WLAN may encompass a neighborhood, a business or university campus, a manufacturing facility, or even a single room having a plurality of computers. Because of this, the transmitters and receivers of a typical WLAN need operate only over a limited range.

The Federal Communications Commission has designated radio bands at 0.9, 2.4, and 5 GHz as unlicensed (i.e., license-free) bands. Being unlicensed, transmitters operating in these bands are legislatively limited in output power, and thereby in range. These limited ranges pose no problem for WLANs that only require limited ranges in the first place.

To some degree, the range is further limited by the specific implementation of the WLAN. For example, Bluetooth™ is a short-range wireless protocol aimed at simplifying communications and data synchronization among computers, other devices, and the Internet. A Bluetooth-implemented WLAN can send data at rates of up to 1 megabits per second (Mbps) in the unlicensed 2.4 GHz radio band over transmitter-to-receiver distances or “hops” of up to 100 m. Therefore, if a Bluetooth-implemented WLAN were used to cover a 2 km square college campus and a portable computer randomly located on the campus were to be allowed to communicate with a parent network through a WLAN access point, it would be necessary to have a access point located every 200 m throughout the campus. A total of 100 access points would be required to provide full coverage.

Alternatively, IEEE 802.11b is a similar short-range wireless protocol aimed at simplifying and standardizing data communications among computers, other devices, and the Internet. A WLAN implemented using IEEE 802-11b can send data at rates of up to 11 Mbps in the unlicensed 2.4 GHz radio band over hops of up to 300 m. Therefore, if an IEEE 802b-implemented WLAN were used to cover the same 1.6 km square college campus, it would be necessary to have an access point located every 600 m throughout the campus, for a total of 13 access points.

Those skilled in the art will appreciate that the Bluetooth and IEEE 802.11b schemes described hereinbefore are exemplary only. Many different schemes may be used to meet the requirements of any given WLAN. However, regardless of scheme, it would be desirable to require as few access points as possible for a given coverage area because the cost of access points contribute directly to system overhead.

For coverage over a constrained area, an ad hoc WLAN (i.e., a transient peer-to-peer WLAN) may be implemented as required. Larger WLANs, such as those in a fixed wireless network (a fixed WLAN) are not so easily implemented. A fixed WLAN refers to a network of wireless devices that are situated in fixed locations, such as an office or home, as opposed to devices that are mobile, such as portable computers. The advantages of fixed WLANs include the ability to connect with devices in remote areas without the need for cables. This may be especially advantageous in retrofit applications, where it may not be practical or cost effective to run new cables.

A problem exists with fixed WLANs using the unlicensed 0.9, 2.4, and 5 GHz radio bands, as do the Bluetooth- and IEEE 802.11-implemented WLANs discussed hereinbefore. In order to effect connection between a user and an external network (e.g., the Internet), a large number of access points is required. These access points are typically hardwired to the external network. This means that a both a wired connection and a wireless connection is required at each access point. This necessitates a physical infrastructure, which makes the access points more expensive than corresponding wireless-only devices. The cost of each access point and the number of access points required for full coverage significantly impact the overall cost of network installation and maintenance.

In most WLANs, the basic device is a personal computer (PC). A typical small WLAN may be formed of a number of PCs wirelessly connected to an access point and through the access points to the parent network. That is, the WLAN is a daughter network, the Internet or external network serves as a parent network, and the access point serves as the inter-network gateway. Depending upon the configuration of the WLAN, at least some of the PCs may also be wirelessly connected directly to each other. This is analogous to an Ethernet-implemented LAN having multiple computers and a broadband modem as an Internet port.

Because a fixed WLAN is fixed, the WLAN loses flexibility. Each device is in a predetermined location in a fixed WLAN. A user must therefore go to that location to use that device. A fixed WLAN, therefore, has only the absence of the inter-device wiring as an advantage over a hardwired LAN. Also, a fixed WLAN may suffer the disadvantage of requiring a plurality of access points.

A WLAN may be composed of a composite network having some devices at fixed locations, e.g., access points and desktop PCs, while other devices are not fixed, e.g., portable computers and personal digital assistants (PDAs). This arrangement, while more flexible than a purely fixed network, does not eliminate the need for a plurality of access points to fully cover the network area.

By using repeaters, a WLAN may cover a wider area than would otherwise be practical. This creates a problem of channel assignment and interference. The channel assignment and interference problem limits the use of repeaters to specialized conditions.

Another problem confronting a WLAN is the elimination and/or maintenance of a proper Fresnel zone. A Fresnel zone is the area around a transmitter into which the radio waves propagate. This area must be clear or else signal strength will weaken. Conductive and/or absorptive objects may distort the Fresnel zone. In the unlicensed 2.4 GHz band, for example, signals pass readily through structures non-conductive and non-absorptive to microwaves, but not through structures either conductive or absorptive of microwaves. This may result in a non-uniform Fresnel zone having “dead areas.” These dead areas may be created by metallic objects, such as statues and some buildings, or by objects containing moisture, such as fountains and foliage. For example, communication over a college campus may be inhibited by a large tree. The tree, containing a significant amount of moisture, effectively absorbs the microwave radiation from an access-point transmitter. This results in distortion of the Fresnel zone producing a “shadow” in which reception of an access-point signal in impeded.

### SUMMARY OF THE INVENTION

Accordingly, it is an advantage of the present invention that a connectionless communication network and wireless channel allocation method therefor are provided.

It is another advantage of the present invention that a connectionless communication network is provided that serves as a daughter network to a parent network.

It is another advantage of the present invention that a connectionless communication network is provided that may utilize an unlicensed radio band.

It is another advantage of the present invention that a connectionless communication network is provided that utilizes a short-range wireless protocol.

It is another advantage of the present invention that a connectionless communication network is provided that utilizes a multihop communication scheme.

It is another advantage of the present invention that a connectionless communication network is provided that is a composite wireless local-area network incorporating a plurality of forwarding access points coupled to a single hub access point.

The above and other advantages of the present invention are carried out in one form by a communication network configured as a daughter network coupled to a parent network. The communication network includes a hub access-point device coupled to the parent network and configured to engage in connectionless outward communication over a first wireless channel. The communication network also includes a plurality of forwarding access-point devices, wherein first and second portions of the plurality of forwarding access-point devices are configured to engage in connectionless inward and outward communications, respectively, over the first and second wireless channels. The communication network also includes a plurality of customer-premise-equipment devices, wherein each customer-premise-equipment device is configured to engage in connectionless inward communication over the second wireless channel, and wherein the hub access-point device is in communication with one of the customer-premise-equipment devices through a forwarding access-point device in each of the first and second portions of the plurality of forwarding access-point devices.

The above and other advantages of the present invention are carried out in another form by a method of allocating wireless channels in a communication network. The method includes coupling a hub access-point device to a parent network, configuring N−1 forwarding access-point devices, where N is a positive integer greater than 1, wherein for M=M_{MIN}=1 to M=M_{MAX}=(N−1) each M^{th} forwarding access-point device is configured to engage in connectionless inward communication over an M^{th} wireless channel and to engage in connectionless outward communication over an (M+1)^{th} wireless channel, configuring the hub access-point device to engage in connectionless outward communication over the M_{MIN}^{th} wireless channel, configuring a customer-premise-equipment device to engage in connectionless inward communication over the M_{MAX}^{th} wireless channel, establishing a hub-user communication link having N hops between the hub access-point device and the customer-premise-equipment device through N−1 sequential ones of the forwarding access-point devices, and executing the connectionless outward and inward communications over the hub-user communication link.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a plan view of a connectionless communication network having six exemplary hub-user communication links in accordance with a preferred embodiment of the present invention;

FIG. 2 shows a schematic representation of the six exemplary hub-user communication links of FIG. 1 in accordance with a preferred embodiment of the present invention;

FIG. 3 shows a plan view of the connectionless communication network of FIG. 1 demonstrating channel-usage rings in accordance with a preferred embodiment of the present invention;

FIG. 4 shows a plan view of the connectionless communication network of FIG. 1 demonstrating communication ranges in accordance with a preferred embodiment of the present invention;

FIG. 5 shows a plan view of the connectionless communication network of FIG. 1 demonstrating interference ranges in accordance with a preferred embodiment of the present invention; and

FIG. 6 shows a plane view of a connectionless communication network demonstrating a hub-user communication link from one customer-premise-equipment device to each of two hub access point devices in accordance with an alternative preferred embodiment of the present invention.

### DETAILED DESCRIPTION OF THE PREFERRED EMBODIMENTS

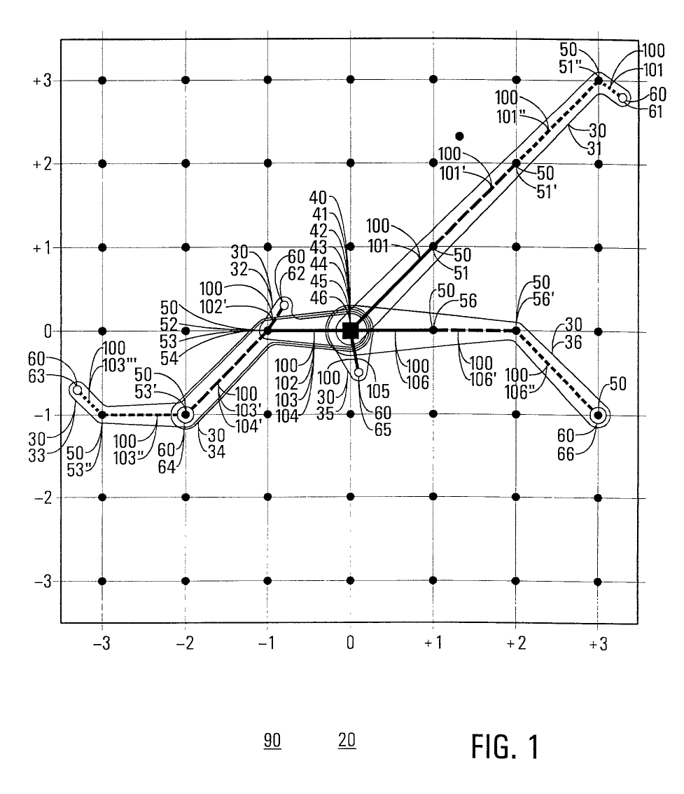

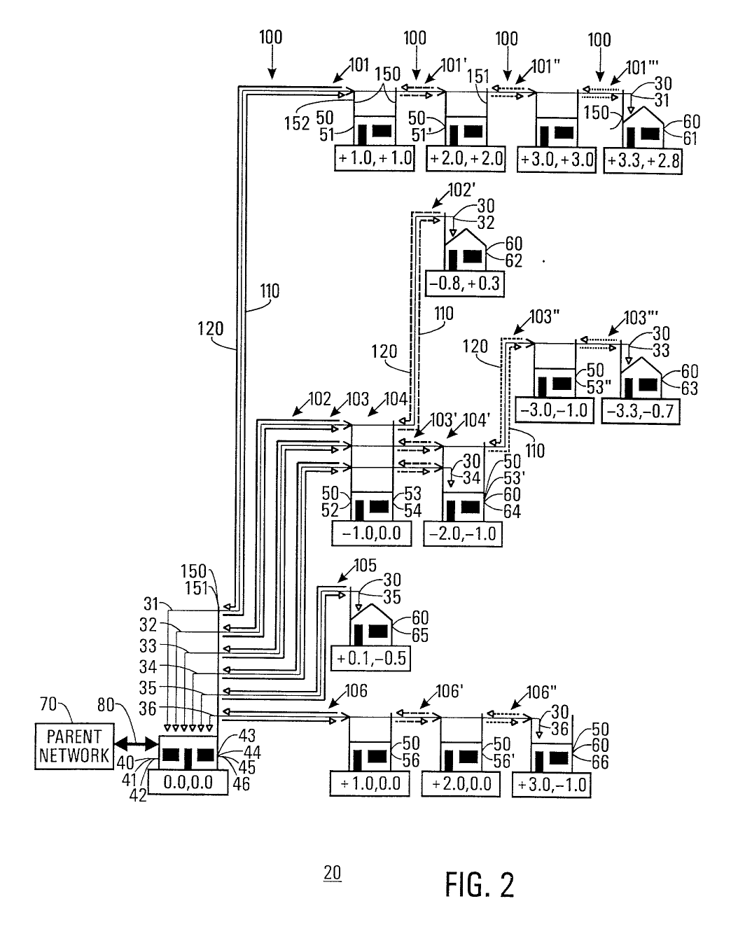

FIG. 1 shows a plan view of a connectionless communication network 20 having six exemplary hub-user communication links 30, and FIG. 2 shows a schematic representation of exemplary hub-user communication links 30 in accordance with a preferred embodiment of the present invention.

Communication network 20 is made up of a hub access-point (HAP) device 40, a plurality of forwarding access-point (FAP) devices 50, and a plurality of customer premise-equipment (CPE) devices 60. In the preferred embodiment, communication network 20 is configured as a daughter network coupled to a parent network 70 (FIG. 2). Parent network 70 may be the Internet, and HAP device 40 may be coupled to parent network 70 via a hard-wired connection 80 (e.g., Ethernet).

Each CPE device 60 is coupled to HAP device 40 via a hub-user communication link 30. FIGS. 1 and 2 demonstrate six such links 30.

Communication network 20 is a multihop connectionless communication network. Through the use of FAP devices 50, network 20 can be configured to minimize the use of resources over a region 90 in which communications services are to be provided. FIG. 1 depicts region 90 as containing connectionless communication network 20. For purposes of clarity, region 90 is exemplified as a seven-unit Cartesian square having HAP device 40 at an origin, FAP devices 50 at integral intersections, and CPE devices occurring anywhere in region 90. Those skilled in the art will appreciate that region 90 may assume any desired shape without departing from the spirit of the present invention.

Within each communication link 30, communications between adjacent devices 40, 50, and 60 are effected via communications “hops” 100. Each hop 100 may be made up of a bidirectional connectionless outward communication 110 and a bidirectional connectionless inward communication 120. Outward communications 110 are those wireless and connectionless communications having an outward transmission (not shown), i.e., a signal transmitted in a direction pointing along link 30 away from HAP device 40, and, at substantially the same time, an inward reception (not shown), i.e., a signal received from a direction pointing along link 30 towards HAP device 40. Similarly, inward communications 120 are those wireless and connectionless communications having an inward transmission (not shown), i.e., a signal transmitted in a direction pointing along link 30 towards HAP device 40, and, at substantially the same time, an outward reception (not shown, i.e., a signal received from a direction pointing along link 30 away from HAP device 40.

In a first communication link 31, HAP device 40 at position (0,0), serving here as a first-link HAP device 41, communicates with FAP device #50 at position (+1,+1), serving as a first first-link FAP device 51, via a first first-link hop 101. First first-link FAP device 51 communicates with FAP device 50 at position (+2,+2), serving as a second first-link FAP device 51′, via a second first-link hop 101′. Second first-link FAP device 51′ communicates with FAP device 50 at position (+3,+3), serving as a third first-link FAP device 51″, via a third first-link hop 101″. Third first-link FAP device 51″ communicates with CPE device 60 at position (+3.3,+2.8), serving as a first-link CPE device 61, via a fourth first-link hop 101′″.

In a second communication link 32, HAP device 40 at position (0,0), serving here as a second-link HAP device 42, communicates with FAP device #50 at position (−1,0), serving here as a (first) second-link FAP device 52, via a first second-link hop 102. (First) second-link FAP device 52 communicates with CPE device 60 at position (−0.8,+0.3), serving as a second-link CPE device 62, via a second second-link hop 102′.

In a third communication link 33, HAP device 40 at position (0,0), serving here as a third-link HAP device 43, communicates with FAP device #50 at position (−1,0), serving here as a first third-link FAP device 53, via a first third-link hop 103. First third-link FAP device 53 communicates with FAP device 50 at position (−2,−1), serving here as a second third-link FAP device 53′, via a second third-link hop 103′. Second third-link FAP device 53′ communicates with FAP device 50 at position (−3,−1), serving as a third third-link FAP device 53″, via a third third-link hop 103″. Third third-link FAP device 53″ communicates with CPE device 60 at position (−3.3,−0.7), serving as a third-link CPE device 63, via a fourth third-link hop 103′″.

In a fourth communication link 34, HAP device 40 at position (0,0), serving here as a fourth-link HAP device 44, communicates with FAP device #50 at position (−1,0), serving here as a (first) fourth-link FAP device 54, via a first fourth-link hop 104. (First) fourth-link FAP device 54 communicates with CPE device 60 at position (−2.0,−1.0), serving as a fourth-link CPE device 64, via a second fourth-link hop 104′.

In a fifth communication link 35, HAP device 40 at position (0,0), serving here as a fifth-link HAP device 45 communicates with CPE device #60 at position (+0.1,−0.5), serving as a fifth-link CPE device 65, via a (first) fifth-link hop 105.

In a sixth communication link 36, HAP device 40 at position (0,0), serving here as a sixth-link HAP device 46 communicates with FAP device #50 at position (+1,0), serving as a first sixth-link FAP device 56, via a first sixth-link hop 106. First sixth-link FAP device 56 communicates with FAP device 50 at position (+2,0), serving as a second sixth-link FAP device 56′, via a second sixth-link hop 106′. Second sixth-link FAP device 56′ communicates with CPE device 60 at position (+3.0,−1.0), serving as a sixth-link CPE device 66, via a third sixth-link hop 106″.

The six exemplary hub-user communication links 31, 32, 33, 34, 35, and 36 bidirectionally connect HAP device 40 located at position (0,0) with each of six CPE devices 60 located at positions (+3.3,+2.8), (−0.8,+0.3), (−3.3,−0.7), (−2.0,−1.0), (+0.1,−0.5), and (+3.0,−1.0), respectively. Exemplary links 30 and the devices 40, 50, and 60 and hops 100 contained therein are summarized in Table 1:

TABLE 1
Exemplary HAP-User Communication Links

| | | | | 1^{st} | | | 2^{nd} | | | 3^{rd} | | | | | |
|---|---|---|---|---|---|---|---|---|---|---|---|---|---|---|---|
| Link | | HAP | | Hop | 1^{st} FAP | | Hop | 2^{nd} FAP | | Hop | 3^{rd} FAP | | 4^{th} | CPE Device | |
| 30 | | Device 40 | | 100 | Device 50 | | 100 | Device 50 | | 100 | Device 50 | | Hop | 60 | |
| Link | Ref. | Loc. | Ref. | Ref. | Loc. | Ref. | Ref. | Loc. | Ref. | Ref. | Loc. | Ref. | 100 | Loc. | Ref. |
| 1^{st} | 31 | 0,0 | 41 | 101 | +1,+1 | 51 | 101′ | +2,+2 | 51′ | 101″ | +3,+3 | 51″ | 101″′ | +3.3,+2.8 | 61 |
| 2^{nd} | 32 | 0,0 | 42 | 102 | −1,0 | 52 | 102′ | — | — | — | — | — | — | −0.8,+0.3 | 62 |
| 3^{rd} | 33 | 0,0 | 43 | 103 | −1,0 | 53 | 103′ | −2,−1 | 53′ | 103″ | −3,−1 | 53″ | 103″′ | −3.3,−0.7 | 63 |
| 4^{th} | 34 | 0,0 | 44 | 104 | −1,0 | 54 | 104′ | — | — | — | — | — | — | −2.0,−1.0 | 64 |
| 5^{th} | 35 | 0,0 | 45 | 105 | — | — | — | — | — | — | — | — | — | +0.1,−0.5 | 65 |
| 6^{th} | 36 | 0,0 | 46 | 106 | +1,0 | 56 | 106′ | +2,0 | 56′ | 106″ | — | — | — | +3.0,−1.0 | 66 |

Network 20 can substantially simultaneously serve multiple communication links 30. That is, multiple CPE devices 60 can concurrently engage in communication sessions with parent network 70 through HAP device 40. It can be seen from Table 1 that HAP device 40, at position (0,0), serves as first-link HAP device 41, as second-link HAP device 42, as third-link HAP device 43, as fourth-link HAP device 44, as fifth-link HAP device 45, or as sixth-link HAP device 46, depending upon which of links 31, 32, 33, 34, 35, or 36 is being referenced.

Similarly, an FAP device 50 may substantially simultaneously serve more than one link 30. It can be seen from Table 1 that FAP device 50 at position (−1,0) serves as (first) second-link FAP device 52, as first third-link FAP device 53, and as (first) fourth-link FAP device 54, depending upon which of links 32, 33, or 34 is being referenced.

FAP devices 50 contain components for outward communications 110 and inward communications 120. CPE devices 60 contain components for inward communication 120. Therefore, FAP devices 50 can be considered supersets of CPE devices 60. A given FAP device can be capable of functioning as both an FAP device and a CPE device 60. FIG. 1 shows that the FAP device #50 at position (−2,−1) is also a CPE device #60. It may be seen in Table 1 that this device serves as second third-link FAP device 50′ when third link 33 is being referenced, and as fourth-link CPE device 64 when link 34 is being referenced. Similarly, FIG. 1 shows that the FAP device #50 at position (+3,−1) is also a CPE device #60. This device serves as sixth-link CPE device 66 when link 36 is being referenced.

Communication network 20 is a multihop connectionless communication network configured as a wireless local-area network (WLAN). As discussed hereinbefore and summarized in Table 1, network 20 allows multiple hops to effect a communication link 30. Of the six exemplary communication links 31, 32, 33, 34, 35, and 36, only fifth communication link 35 is not a multihop link 30. Those skilled in the art will appreciate that a link 30 may have any number of hops 100, and that no link 30 is required to have any specific number of hops 100.

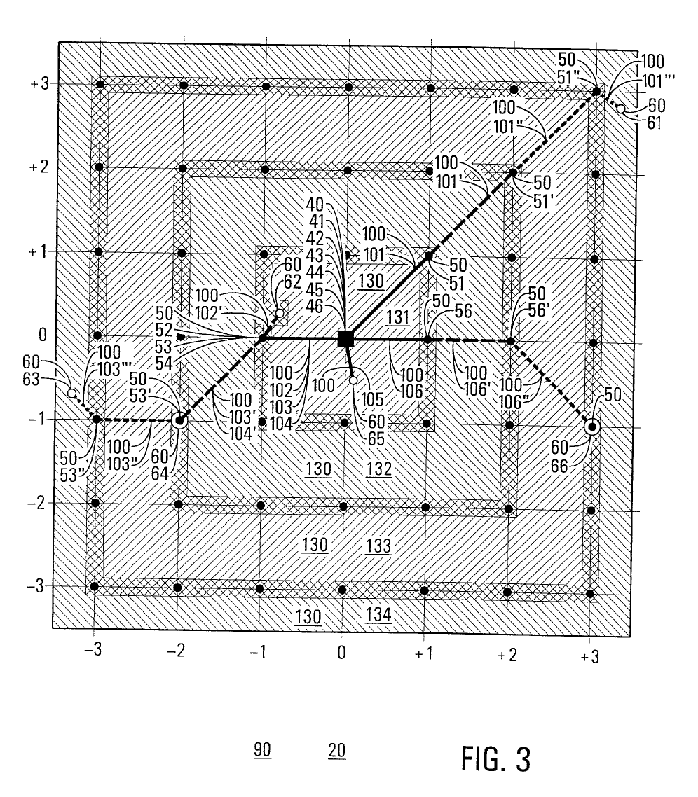

FIG. 3 shows a plan view of connectionless communication network 20 demonstrating channel-allocation rings 130 in accordance with a preferred embodiment of the present invention. The following discussion refers to FIGS. 1 through 3.

In the preferred embodiment, communication network 20 supports connectionless communication in the unlicensed 0.9, 2.4, and 5 GHz radio bands using connectionless protocols, such as the Bluetooth™ and IEEE 802.11b protocols. Resources are instantaneously taken and released for the duration the transfer of each data packet. This provides an efficient use of the spectrum in those bands.

Network 20 engages in bidirectional outward and inward communication 110 and 120 over each hop 100 of each link 30. That is, each device 40 or 50 on a more inward end of a hop 100 engages in connectionless outward communication 110 with a device 50 or 60 on a more outward end of the hop 100. Similarly the device 50 or 60 on the more inward end of the hop 100 engages in connectionless inward communication 110 with the device 40 or 50 on the more inward end of that hop 100. In four-hop first link 31, HAP device 41 is in bidirectional communication with CPE device 61 through FAP devices 51, 51′, and 51″ over hops 101, 101′, 101″, and 101′″. In two-hop second link 32, HAP device 42 is in bidirectional communication with CPE device 62 through FAP device 52 over hops 102 and 102′. In four-hop third link 33, HAP device 43 is in bidirectional communication with CPE device 63 through FAP devices 53, 53′, and 53″ over hops 103, 103′, 103″, and 103′″. In two-hop fourth link 34, HAP device 44 is in bidirectional communication with CPE device 64 through FAP device 54 over hops 104 and 104′. In one-hop fifth communication link 35, HAP device 45 is thereby in bidirectional communication with CPE device 65 over hop 105. In three-hop sixth communication link 36, HAP device 46 is in bidirectional communication with CPE device 66 through FAP devices 56 and 56′ over hops 106, 106′, and 106″.

Were all the outward and inward communications 110 and 120 in a link to be performed at the same frequency, interference might become a problem. To resolve the potential interference problem, the conjoined hops 100 at each FAP device 50 in a link 30 are allocated different wireless channels (not shown). In the preferred embodiment, the channels are differentiated by frequency. Therefore, conjoined channels at each FAP device 50 in link 30 have different frequencies (not shown). Those skilled in the art will appreciate that channel differentiation other than through frequencies (e.g., CDMA) may be used without departing from the spirit of the present invention.

This allocation is accomplished though the use of channel allocation rings 130. FIG. 3 demonstrates four allocation rings 130. As demonstrated, each allocation ring 130 encompasses a portion of the totality of FAP devices 50 within region 90 of communication network 20. These portions overlap, i.e., each FAP device 50 exists in more than one allocation ring 130.

A first channel allocation ring 131 encompasses a portion of region 90 where hops 100 may be allocated a first wireless channel. First allocation ring 131 encompasses HAP device 40, a portion of the totality of FAP devices 50 within region 90 made up of one-hop-removed FAP devices 50, and that portion of the totality of CPE devices 60 within region 90 made up of one-hop-removed CPE devices 60. One-hop-removed FAP and CPE devices 50 and 60 are those FAP and CPE devices 50 and 60 capable of being coupled to HAP device 40 by one hop 100.

A second channel allocation ring 132 encompasses a portion of region 90 where hops 100 may be allocated a second wireless channel. Second allocation ring 132 encompasses that portion of the totality of FAP devices 50 within region 90 made up of both one- and two-hop-removed FAP devices 50, and that portion of the totality of CPE devices 60 within region 90 made up of two-hop removed CPE devices 60. Two-hop-removed FAP and CPE devices 50 and 60 are those FAP and CPE devices 50 and 60 further removed from HAP device 40 than one-hop-removed FAP devices 50 and capable of being coupled to one of one-hop-removed FAP devices 50 by one hop 100.

A third channel allocation ring 133 encompasses a portion of region 90 where hops 100 may be allocated a third wireless channel. Third allocation ring 133 encompasses that portion of the totality of FAP devices 50 within region 90 made up of both two- and three-hop-removed FAP devices 50, and that portion of the totality of CPE devices 60 within region 90 made up of three-hop-removed CPE devices 60. Three-hop-removed FAP and CPE devices 50 and 60 are those FAP and CPE devices 50 and 60 further removed from HAP device 40 than two-hop-removed FAP devices 50 and capable of being coupled to one of two-hop-removed FAP devices 50 by one hop 100.

A fourth channel allocation ring 134 encompasses a portion of region 90 where hops 100 may be allocated a fourth wireless channel. Fourth allocation ring 134 encompasses that portion of the totality of FAP devices 50 within region 90 made up of three-hop-removed FAP devices 50, and that portion of the totality of CPE devices 60 within region 90 made up of four-hop-removed CPE devices 60. Four-hop-removed CPE devices 60 are those CPE devices 60 further removed from HAP device 40 than three-hop-removed FAP devices 50 and capable of being coupled to one of three-hop-removed FAP devices 50 by one hop 100.

Those skilled in the art will appreciate that the limitations of network 20 as demonstrated in FIG. 3 are not a requirement of the present invention. FIG. 3 demonstrates only four allocation rings 130 in a square region 90 of network 20. Region 90 may be expanded to any desired size shape, and incorporate any desired number of allocation rings 130 without departing from the spirit of the present invention.

Those skilled in the art will also appreciate that allocation rings 130 are spatial and not geographic. That is, FAP devices 50 may be located anywhere desired, without regard to a physical distance from HAP device 40. For example, a needed topology may require that a given third-ring FAP device 50 be physically closer to HAP 40 than a given second-ring FAP device 50. Any allocation ring 130 may be distorted, divided, or otherwise shaped to conform to needs of region 90 of network 20 without departing from the spirit of the present invention.

As discussed hereinbefore, conjoined hops 100 are assigned to different channels (not shown). Therefore, adjacent channel allocation rings 130 may allocate different channels. This is not a requirement of the present invention, however, and adjacent channel allocation rings 130 may share a channel when the capacity of the channel is greater than the capacity of both rings 130 combined.

FIG. 3 demonstrates six communication links 30 within four allocation rings 130. In four-hop first link 31, first hop 101 is effected over a first wireless channel within first ring 131, second hop 101′ is effected over a second wireless channel within second ring 132, third hop 101″ is effected over a third wireless channel within third ring 133, and fourth hop 101′″ is effected over a fourth wireless channel within fourth ring 134. In two-hop second link 32, first hop 102 is effected over the first wireless channel within first ring 131, and second hop 102′ is effected over the second wireless channel within second ring 132. In four-hop third link 33, first hop 103 is effected over the first wireless channel within first ring 131, second hop 103′ is effected over the second wireless channel within second ring 132, third hop 103″ is effected over the third wireless channel within third ring 133, and fourth hop 103′″ is effected over the fourth wireless channel within fourth ring 134. In two-hop fourth link 33, first hop 104 is effected over the first wireless channel within first ring 131, and second hop 104′ is effected over the second wireless channel within second ring 132. In one-hop fifth link 35, (first) hop 105 is effected over the first wireless channel within first ring 131. In three-hop sixth link 36, first hop 106 is effected over the first wireless channel within first ring 131, second hop 106′ is effected over the second wireless channel within second ring 132, and third hop 106″ is effected over the third wireless channel within third ring 133.

Subject to exceptions discussed hereinafter, each of the first, second, third, and fourth wireless channels is a different wireless channel. In the preferred embodiment, therefore, each of the first, second, third, and fourth wireless channels, i.e., each of hops 100 in each of communication links 30, is provided at a different frequency.

A hub-user communication link 30 can be established between HAP device 40 and a given CPE device 60 anywhere within region 90. Link 30 thus established has N hops 100 between HAP device 40 and CPE device 60, where N is a positive integer. Link 30 passes through N−1 sequential FAP devices 50 between HAP device 40 and CPE device 60. This is demonstrated in Table 2:

TABLE 2
Exemplary Link Hops and FAP Devices

| | | FAP | HAP | | | 1^{st} FAP | | | 2^{nd} FAP | | | 3^{rd} FAP | | | CPE |
|---|---|---|---|---|---|---|---|---|---|---|---|---|---|---|---|
| Link | Hops | Devices | Device | 1^{st} Hop | | Device | 2^{nd} Hop | | Device | 3^{rd} Hop | | Device | 4^{th} Hop | | Device |
| Ref. | N | N − 1 | Ref | Ch. | Ref. | Ref. | Ch. | Ref. | Ref. | Ch. | Ref. | Ref. | Ch. | Ref. | Ref. |
| 31 | 4 | 3 | 41 | 1 | 101 | 51 | 2 | 101′ | 51′ | 3 | 101″ | 51″ | 4 | 101″′ | 61 |
| 32 | 2 | 1 | 42 | 1 | 102 | 52 | 2 | 102′ | — | — | — | — | — | — | 62 |
| 33 | 4 | 3 | 43 | 1 | 103 | 53 | 2 | 103′ | 53′ | 3 | 103″ | 53″ | 4 | 103″′ | 63 |
| 34 | 2 | 1 | 44 | 1 | 104 | 54 | 2 | 104′ | — | — | — | — | — | — | 64 |
| 35 | 1 | 0 | 45 | 1 | 105 | — | — | — | — | — | — | — | — | — | 65 |
| 36 | 3 | 2 | 46 | 1 | 106 | 56 | 2 | 106′ | 56′ | 3 | 106″ | — | — | — | 66 |

HAP device 40 in a given link 30 is configured to engage in connectionless outward communication 110 (FIG. 2) across a 1^{st} hop 100 (i.e., a 1^{st} wireless channel). Similarly, CPE device 60 in that given link 30 is configured to engage in connectionless inward communication 120 (FIG. 2) across an N^{th} hop 100 (i.e., an N^{th} wireless channel). This makes possible a minimal configuration where N=1 and there is only one hop 100.

Table 2 demonstrates the minimal one-hop (N=1) configuration for the fifth communication link 35. An HAP device 45 is configured to engage in outward communication 110 across a 1^{st} hop 105. Similarly, a CPE device 65 is configured to engage in inward communication 120 across the 1^{st} (N=1) hop 105. There are no (N−1=0) FAP devices in this minimal configuration.

In configurations other than the minimal, N is greater than 1, and there are N−1 FAP devices 50 in link 30. For each M^{th} FAP device, where M is an integer having a minimum of 1 and a maximum of N−1, i.e., M_{Min}=1 and M_{Max}=N−1, that M^{th} FAP device is configured to engage in connectionless inward communication 120 across an M^{th} hop 100 (i.e., an M^{th} wireless channel) and connectionless outward communication 110 across an (M+1)^{th} hop 100 (i.e., an (M+1)^{th} wireless channel).

Table 2 demonstrates a two-hop (N=2) configuration for the second communication link 32. There is 1 (N−1=1) FAP device 50 in this configuration. An HAP device 42 is configured to engage in outward communication 110 across a 1^{st} hop 102. A sole (M_{Min}=1, M_{MAX}=N−1=1, M=1) FAP device 52 is configured to engage in inward communication 120 across the 1^{st} (M=1) hop 102, and outward communication 110 across a 2^{nd} (M+1=2) hop 102′. A CPE device 62 is configured to engage in inward communication 120 across the 2^{nd} (N=2) hop 102′.

Table 2 demonstrates a three-hop (N=3) configuration for the sixth communication link 36. There are 2 (N−1=2) FAP devices 50 in this configuration. A HAP device 46 is configured to engage in outward communication 110 across a 1^{st} hop 106. A 1^{st} (Mₘᵢₙ=1, M_{Max}=N−1=2, M=1) FAP device 56 is configured to engage in inward communication 120 across the 1^{st} (M=1) hop 106, and outward communication 110 across a 2^{nd} (M+1=2) hop 106′. A 2^{nd} (M_{Min}=1, M_{MAX}=N−1=2, M=2) FAP device 56′ is configured to engage in inward communication 120 across the 2nd (M=2) hop 106′, and outward communication 110 across a 3_{rd} (M+1=3) hop 106″. A CPE device 66 is configured to engage in inward communication 120 across the 3^{rd} (N=3) hop 106″.

Table 2 demonstrates a four-hop (N=4) configuration for the first communication link 31. There are 3 (N−1=3) FAP devices 50 in this configuration. A HAP device 43 is configured to engage in outward communication 110 across a 1^{st} hop 101. A 1^{st} (M_{Min}=1, M_{Max}=N−1=3, M=1) FAP device 51 is configured to engage in inward communication 120 across the 1^{st} (M=1) hop 101, and outward communication 110 across a 2^{nd} (M+1=2) hop 101′. A 2^{nd} (M_{Min}=1, M_{MAX}=N−1=3, M=2) FAP device 51′ is configured to engage in inward communication 120 across the 2^{nd} (M=2) hop 101′, and outward communication 110 across a 3^{rd} (M+1=3) hop 101″. A 3^{rd} (M_{Min}=1, M_{MAX}=N−1=3, M=3) FAP device 51″ is configured to engage in inward communication 120 across the 3^{rd} (M=3) hop 101″, and outward communication 110 across a 4th (M+1=4) hop 101′″. A CPE device 66 is configured to engage in inward communication 120 across the 4th (N=4) hop 106′″.

It can be seen from Table 2 that all like-numbered hops 100 share the same-numbered wireless channel. Similarly, like-numbered hops #100 exclusive use the same-numbered channel. That is, first hops 101, 102, 103, 104, 105, and 106 share the first wireless channel, second hops 101′, 102′, 103′, 104′, and 106′ share the second wireless channel, third hops 101″, 103″, and 106″ share the third wireless channel, and fourth hops 101′″ and 103′″ share the fourth wireless channel.

In the preferred embodiment, hops 100 are desirably assigned communication network 20 wireless channels at frequencies in the unlicensed 0.9, 2.4, and 5 GHz radio bands.

The configuration of devices 40, 50, and 60 involves analyzing communication network 20 to determine potential paths (not shown) between HAP device 40 and CPE device 60, determining which of the potential paths is an optimal path (not shown), i.e., a path having a minimum number of hops 100, for link 30, ascertaining the number of hops 100, and setting N equal to the number of hops 100. These tasks are accomplished by processes well known to those of ordinary skill in the art.

To facilitate configuration, each FAP device 50 is configured to transmit hop-count data (not shown) outward to more-removed FAP devices 50 and CPE devices 60. The hop-count data identifies the hop-removal status of the originating FAP device 50, i.e., whether the FAP device 50 is one-hop removed, two-hops removed, etc. This allows more-removed devices 50 and 60 to select among less-removed devices 40 and 50 to determine an optimal path (not shown) for a communication link 30, i.e., a path having the lowest number of hops 100.

Once all hops 100 in a given communication link 30 have been assigned channels (frequencies), connectionless outward and inward communications 110 and 120 over link 30 is executed.

The number of communication links 30 which HAP device 40 may concurrently handle is determined by a capacity (not shown) of the innermost channel (i.e., the first channel). Each device 40, 50, and 60 in network 20 is configured to transmit and/or receive capacity data (not shown) outward, wherein that capacity data identifies a capacity for forwarding connectionless outward and inward communications 110 and 120. At any given time, the collective capacities of one-hop-removed FAP devices 50 is less than or equal to the capacity of the innermost channel. The capacity of innermost allocation ring 130, therefore, is 100 percent of the capacity of the innermost channel. The capacity of each other allocation ring 130 is no greater than the capacity of the next inner allocation ring 130. This allows the outermost allocation ring 130 to use a lightly loaded channel that may be shared with another nearby network (not shown), or to simultaneously share channel assignments within the same network.

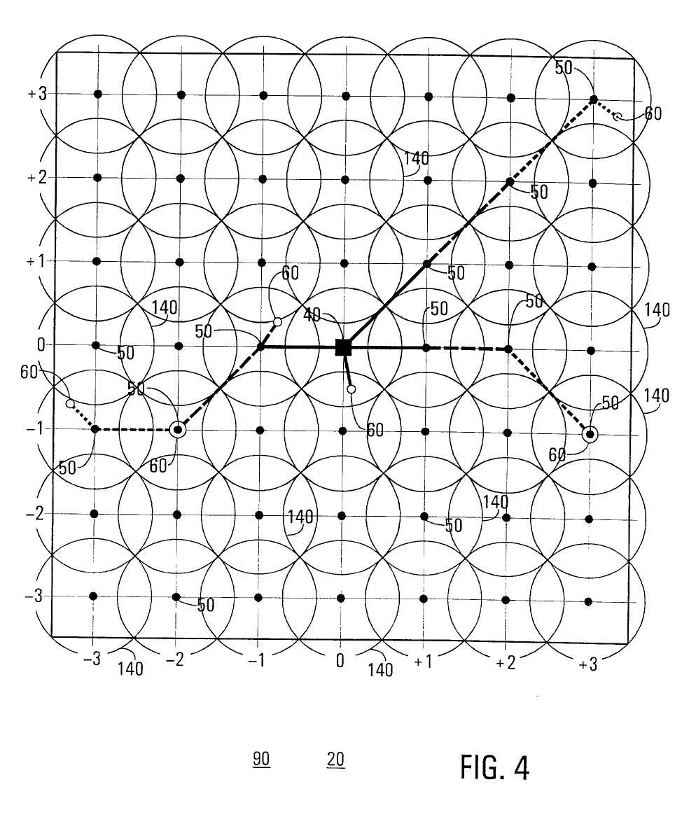

FIG. 4 shows a plan view of connectionless communication network 20 demonstrating communication ranges 140 in accordance with a preferred embodiment of the present invention. The following discussion refers to FIGS. 1, 2, and 4.

Distances within region 90 of communication network 20 are limited by communication ranges 140 of individual transmitters (not shown) and receivers (not shown) within devices 40, 50, and 60. In the preferred embodiment, the use of the unlicensed 0.9, 2.4, and 5 GHz radio bands legislatively limits communication ranges 140. The use of specific connectionless protocols may further limit ranges 140. For example, if the Bluetooth protocol is used in the unlicensed 2.4 GHz radio band, typical hops of up to 100 m are possible. Alternatively, if the IEEE 802.11b protocol is used in the same radio band, typical hops of up to 300 m are possible.

For the sake of convenience, the remainder of this discussion will presume that the IEEE 802.11b protocol is used in the unlicensed 2.4 GHz radio band. Those skilled in the art will appreciate that this presumption is for convenience only and is not a requirement of the present invention.

Communication ranges 140 of devices 40, 50, and 60 in network 20 presume antennas 150 (FIG. 2) which are substantially non-directional antennas 151. Those skilled in the art will appreciate that range may be extended through the use of directional antennas 152. Prior art usage has shown that if the antennas 150 on both ends of a hop 100, i.e., the transmitting and receiving antennas effecting an outward or inward communication 110 or 120 over a single hop 100, are suitably directional, then communication range 140 may be increase by a factor greater than ten for that hop. With the IEEE 802.11b protocol, this gives a potential single-hop range of greater than 3 Km.

The exclusive use of directional antennas 152 for devices 40, 50, and 60 would require multiple directional antennas for many of those devices. This would significantly increase the cost and complexity of network 20 and may not be a practical solution for many applications.

FIG. 4 depicts network 20 as having a single HAP device 40 and forty-eight FAP devices laid out in a seven by seven grid. If all antennas 150 were non-directional antennas 151, the maximum (i.e., diagonal) separation of devices 40 and 50 in region 90 would be 300 m using the IEEE 802.11b protocol. This would limit region 90 to a 1.485 Km square if only four hops are used.

In the preferred embodiment, as depicted in FIG. 2, each FAP device 50 uses a substantially directional antenna 152 for connectionless inward communication 120, and HAP device 40 and each FAP device 50 uses a substantially non-directional antenna 151 for connectionless outward communication 110.

Substantially directional antennas 152 need only have a directionality more directional than the directionality of substantially non-directional antennas 151. That is, substantially non-directional antennas 151 have a directionality of greater than 180° while directional antennas 152 have a directionality of less than 180°.

In the preferred embodiment, substantially non-directional antennas 151 have a desired directionality of approximately 360° and directional antennas 152 have a directionality of approximately 90° aimed to encompass less-removed devices 40 and 50. This arrangement of non-directional and directional antennas 151 and 152 increases the range 140 between devices 40 and 50 by at least a factor of two, thereby extending region 90 to a 2.970 Km square when four hops are used. This doubling of ranges 140 is demonstrated in FIG. 4 by showing the standard ranges 140 of diagonally proximate devices 40 and 50 as being tangential.

Unlike FAP devices 50, CPE devices 60 in the preferred embodiment use a substantially non-directional antenna 151 (FIG. 2) for connectionless inward communication 120. This limits the range between a CPE device 60 and a HAP or FAP device 40 or 50 to the specified 300 m range 140. Therefore, to communicate with an HAP or FAP device 40 or 50, a CPE device must be located with range 140 of that HAP or FAP device 40 or 50 as illustrated in FIG. 4.

Because FAP devices 50 use directional antennas 162 to effect inward communications 120, HAP device 40 and FAP devices 50 are, in the preferred environment, fixed in location. CPE devices 60 may be fixed or portable as desired.

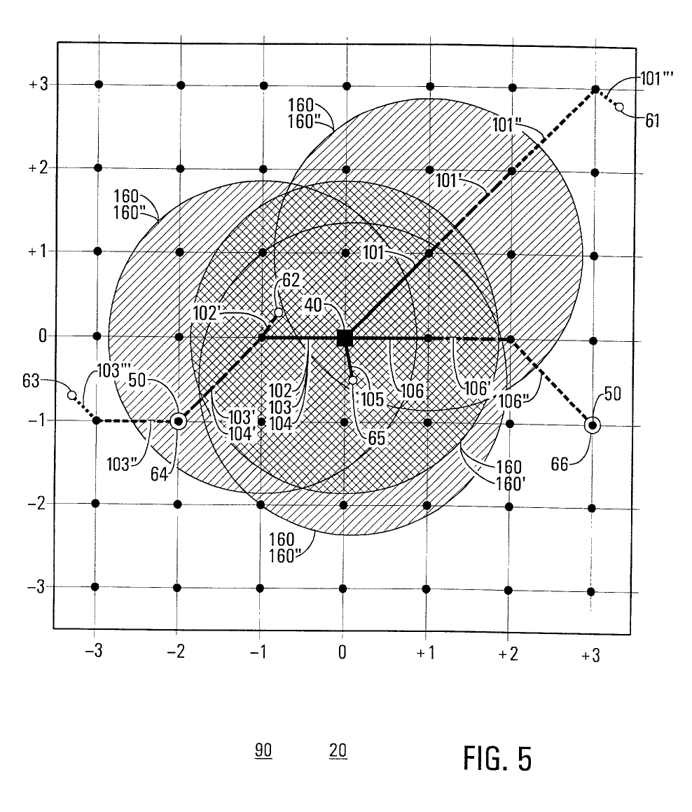

FIG. 5 shows a plan view of connectionless communication network 20 demonstrating interference ranges 160 in accordance with a preferred embodiment of the present invention. The following discussion refers to FIGS. 1, 2, 4, and 5.

Network 20 determines an interference range 160 for each allocated channel (not shown). Each channel, i.e., each hop 100, has two interference ranges 160. For first hop 101, for example, FIG. 5 shows a first interference range 160 for HAP device 40 and a second interference range 160 for FAP device 51.

FIG. 5 demonstrates channel interference ranges for the first channel in all six exemplary communication links 30. That is, interference ranges 160 of all first hops 101, 102, 103, 104, 105, and 106, to which have been allocated the first channel. A composite first-channel interference area 170 is thus formed. First-channel interference area 170 is that portion of region 90 in which the first channel may not be reused.

In the preferred embodiment, each channel is at a different frequency. For each communication link, the configuring of each device 40, 50, and 60, discussed hereinbefore, includes allocating a first wireless channel at a first frequency. Then, for each M^{th} FAP device 50, noting the frequencies of wireless channels of already-configured ones of FAP devices 50 residing in the interference areas 170 in which that M^{th} FAP device resides, assigning to the M^{th} wireless channel a frequency different from the noted frequencies; and assigning to the (M+1)^{th} wireless channel a frequency different from the frequency of the M^{th} wireless channel and different from the noted frequencies.

Those skilled in the art will appreciate that, since network 20 is a connectionless network, the configuration and allocation processes described herein are autonomous. That is, network #20 is inherently self-organizing, and no central controlling authority or device is required. For example, the assigning processed discussed in the preceding paragraph may be effected by simply broadcasting outward on the first channel what channels are to be used for what hops 100. The devices 50 and 60 receiving this broadcast then assign their channels and pass on remaining channel information from the first-channel broadcast.

It can be seen in FIG. 5 that all second hops 101′, 102′, 103′, 104′, and 106′ are within first channel interference area 170. Therefore, no second hop 101′, 102′, 103′, 104′, or 106′ may be allocated the first-channel frequency.

Similarly, it can be seen that all third hops 101″, 103″, and 106″ are at least partially in first channel interference area 170. Therefore, no third hop 101″, 103″, or 106″may be allocated the first-channel frequency.

However, it can be seen that no part of either fourth hops 101′″ or 103′″ has any portion in first channel interference area 170. Therefore, either or both fourth hops 101′″ and/or 103′″ may be allocated the first-channel frequency. This demonstrates an ability of network 20 for channel/frequency reuse. This channel/frequency reuse ability further increases the spectral efficiency of network 20.

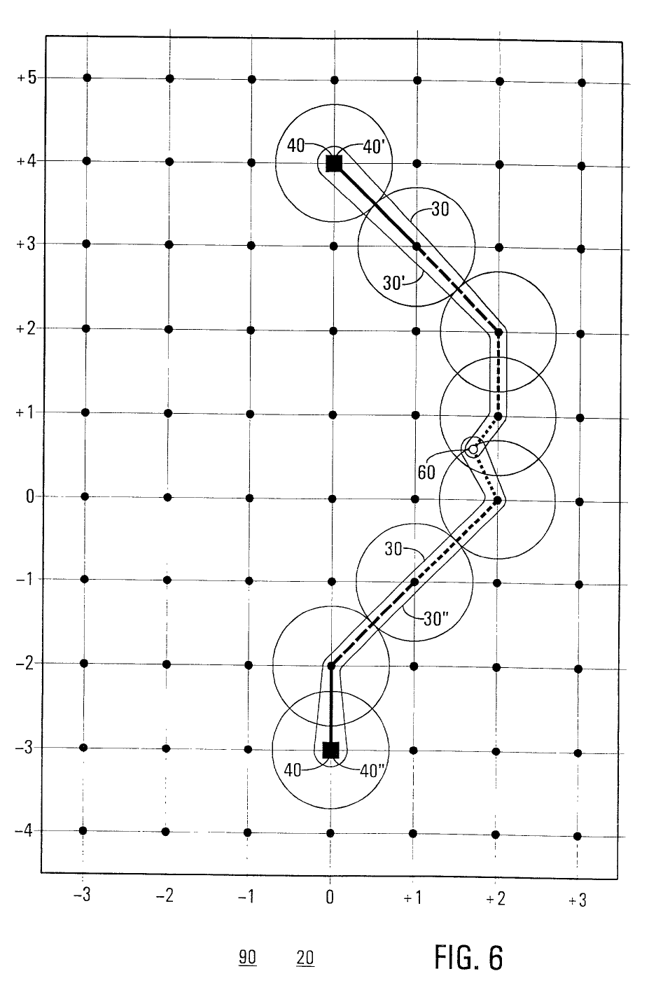

FIG. 6 shows a plane view of connectionless communication network 20 demonstrating hub-user communication links 30 from one CPE device 60 to each of two HAP devices in accordance with an alternative preferred embodiment of the present invention. The following discussion refers to FIGS. 1, 4, and 6.

When region 90 is greater than can be conveniently covered by a network 20 having one HAP device 40, then one of two approaches may be used. In a first approach, multiple one-HAP networks 20 may be used to cover the same region 90. In this case, each network 20 operates as an independent network 20 as discussed hereinbefore. Additional channels not shared by the other networks may be used to avoid interference.

In a second approach, a single network 20 may be formed having multiple HAP devices 40. Each HAP device 40 is desirably capable of being in a link 30 with a CPE device 60, which CPE device 60 is capable of being in a link 30 with another HAP device 40. FIG. 6 demonstrates a network 20 in which a CPE device 60 may be either in a link one 30′ with a HAP device one 40′, or in a link two 30″ with a HAP device two 40″.

A third approach formed of both single-HAP and multiple-HAP networks 20 is also possible.

Those skilled in the art will appreciate that the configuration and formation of links 30 in a multi-HAP network 20 is substantially as described hereinbefore.

In summary, the present invention teaches a connectionless communication network 20 and a method of allocating wireless channels therefor. Network 20 serves as a daughter network to a parent network 70. Network 20 utilizes an unlicensed radio band and a short-range wireless protocol. Network 20 utilizes a multihop communication scheme. Network 20 incorporates a single HAP device 40 coupled to a parent network 70. Network 20 is a composite WLAN incorporating a plurality of FAP devices 50 coupled to a single HAP device 50.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A forwarding communication network configured as a daughter network coupled to a parent network, said communication network comprising:
a hub access-point (HAP) device coupled to said parent network and configured to engage in outward communication over a first wireless channel;
a plurality of forwarding access-point (FAP) devices, wherein a first portion of said plurality of FAP devices is configured to engage in inward communication over said first wireless channel, and wherein a second portion of said plurality of FAP devices is configured to engage in outward communication over a second wireless channel; and
a plurality of customer-premise-equipment (CPE) devices, wherein each CPE device in said plurality of CPE devices is configured to engage in inward communication over said second wireless channel, and wherein said HAP device is in communication with one of said CPE devices through an FAP device in each of said first and second portions of said plurality of FAP devices.

2. A forwarding communication network as claimed in claim 1 additionally comprising an additional CPE device configured to engage in inward communication over said first wireless channel.

3. A forwarding communication network as claimed in claim 1 wherein:
an FAP device in said first portion of said plurality of FAP devices is also said FAP device in said second portion of said plurality of FAP devices;
said HAP device is configured to engage in outward communication with said FAP device over said first wireless channel;
said FAP device is configured to engage in inward communication with said HAP device and is configured to engage in outward communication with said one CPE device over said second wireless channel; and
said one CPE device is configured to engage in inward communication with said FAP device over said second wireless channel.

4. A forwarding communication network as claimed in claim 1 wherein:
said first wireless channel is provided at a first frequency; and
said second wireless channel is provided at a second frequency different from said first frequency.

5. A forwarding communication network as claimed in claim 1 wherein:
a first FAP device is in said first portion of said plurality of FAP devices;
a second FAP device is in said second portion of said plurality of FAP devices;
said HAP device is configured to engage in outward communication with said first FAP device over said first wireless channel;
said first FAP device is configured to engage in inward communication with said HAP device over said first wireless channel and is configured to engage in outward communication with said second FAP device over a third wireless channel;
said second FAP device is configured to engage in inward communication with said first FAP device over said third wireless channel and is configured to engage in outward communication with said CPE device over said second wireless channel; and
said one CPE device is configured to engage in inward communication with said second FAP device over said second wireless channel.

6. A forwarding communication network as claimed in claim 1 wherein said communication network additionally comprises a hub-user communication link of N hops, where N is a positive integer greater than 1, and wherein:
said hub-user communication link couples said HAP device to said one CPE device through N−1 sequential ones of said FAP devices; and
each of said hops is effected over a wireless channel having a frequency different from frequencies of wireless channels of conjoined ones of said hops.

7. A forwarding communication network as claimed in claim 1 wherein:
an FAP device in one of said first and second portions of said plurality of FAP devices effects said inward communication with a first directionality; and
said FAP device effects said outward communication with a second directionality, wherein said first directionality is more directional than said second directionality.

8. A forwarding communication network as claimed in claim 1 wherein an FAP device in said plurality of FAP devices includes one of said CPE devices.

9. A forwarding communication network as claimed in claim 1 wherein each of said outward and inward communications is bidirectional.

10. A forwarding communication network as claimed in claim 1 wherein said HAP device is a first HAP device, and wherein said communication network additionally comprises a second HAP device coupled to said parent network and configured to engage in outward communication.

11. A forwarding communication network as claimed in claim 1 wherein said inward communication is connectionless inward communication and said outward communication is connectionless outward communication.

12. A forwarding communication network configured to minimize system resources over a region in which communication services are provided, said communication network comprising:
a hub access-point (HAP) device coupled to a parent network and configured to engage in connectionless first-hop outward transmissions;
a forwarding access-point (FAP) device configured to engage in connectionless first-hop inward transmissions and in connectionless second-hop outward transmissions;
a first plurality of customer-premise-equipment (CPE) devices, wherein each CPE device in said first plurality of CPE devices is configured to engage in connectionless first-hop inward transmissions, wherein a first wireless channel is shared among said connectionless first-hop outward and inward transmissions; and
a second plurality of CPE devices, wherein each CPE device in said second plurality of CPE devices is configured to engage in connectionless second-hop inward transmissions, wherein a second wireless channel is shared among said connectionless second-hop outward and inward transmissions.

13. A forwarding communication network as claimed in claim 12 wherein said CPE devices in said first and second pluralities of CPE devices are configured to concurrently engage in communication sessions through said parent network.

14. A forwarding communication network as claimed in claim 13 wherein:
connectionless outward and inward communications with said CPE devices in said first plurality of CPE devices during said communication sessions are conveyed over said first wireless channel exclusively; and
connectionless outward and inward communications with said CPE devices in said second plurality of CPE devices during said communication sessions are conveyed over said first and second wireless channels.

15. A forwarding communication network as claimed in claim 12 wherein:
said FAP device is configured to transmit hop-count data, wherein said hop-count data identifies said FAP device is one hop removed from said HAP device; and
each CPE device in said second plurality of CPE devices is configured to receive said hop-count data.

16. A forwarding communication network as claimed in claim 12 wherein said FAP device is a first FAP device and wherein said communication network additionally comprises:
a second FAP device configured to engage in connectionless second-hop inward transmissions and in connectionless third-hop outward transmissions; and
a third plurality of CPE devices, wherein each CPE device in said third plurality of CPE devices is configured to engage in connectionless third-hop inward transmissions, wherein a third wireless channel is shared among said connectionless third-hop outward and inward transmissions.

17. A forwarding communication network as claimed in claim 16 wherein:
said CPE devices in said first, second, and third pluralities of CPE devices are configured to concurrently engage in communication sessions though said parent network;
connectionless outward and inward communications with said CPE devices in said first plurality of CPE devices during said communication sessions are conveyed over said first wireless channel exclusively;
connectionless outward and inward communications with said CPE devices in said second plurality of CPE devices during said communication sessions are conveyed over said first and second wireless channels exclusively; and
connectionless outward and inward communications with said CPE devices in said third plurality of CPE devices during said communication sessions are conveyed over said first, second, and third wireless channels.

18. A forwarding communication network as claimed in claim 16 wherein:
said first FAP device includes a directional antenna aimed at said HAP device; and
said second FAP device includes a directional antenna aimed at said first FAP device.

19. A forwarding communication network as claimed in claim 16 wherein:
said HAP device, said first FAP device, and said second FAP device are each configured to transmit hop-count data, wherein said hop-count data identifies a number of hops to said HAP device; and
said first FAP device, said second FAP device, and said CPE devices in said first, second, and third pluralities of CPE devices are each configured to receive said hop-count data.

20. A forwarding communication network as claimed in claim 16 wherein:
said first FAP device and said second FAP device are each configured to transmit capacity data, wherein said capacity data identifies a capacity for forwarding connectionless inward transmissions toward said HAP device; and
said second FAP device and said CPE devices in said second and third pluralities of CPE devices are each configured to receive said capacity data.

21. A forwarding communication network as claimed in claim 16 wherein each of said first, second, and third wireless channels occupies an unlicensed portion of the radio spectrum.

22. A forwarding communication network as claimed in claim 16 wherein said HAP device, said first and second FAP devices, and said CPE devices in said first, second, and third pluralities of CPE devices are operated in accordance with an IEEE 802.11 standard for wireless local area networks.

23. A forwarding communication network as claimed in claim 16 wherein:
said first wireless channel is provided at a first frequency;
said second wireless channel is provided at a second frequency different from said first frequency; and
said third wireless channel is provided at a third frequency different from said first and second frequencies.

24. A forwarding communication network as claimed in claim 12 wherein:
said HAP and FAP devices are substantially stationary; and
said FAP device includes a directional antenna aimed at said HAP device.

25. A forwarding communication network as claimed in claim 12 wherein said FAP device includes one of said CPE devices in said first plurality of CPE devices.

26. A forwarding communication network as claimed in claim 12 wherein:
said HAP device is configured to receive said connectionless first-hop inward transmissions conveyed by said first wireless channel;
said FAP device is configured to receive said connectionless first-hop outward transmissions conveyed by said first wireless channel;
said FAP device is additionally configured to receive said connectionless second-hop inward transmissions conveyed by said second wireless channel;
each CPE device in said first plurality of CPE devices is configured to receive said connectionless first-hop outward transmissions conveyed by said first wireless channel; and
each CPE device in said second plurality of CPE devices is configured to receive said connectionless second-hop outward transmissions conveyed by said second wireless channel.

27. A method of allocating wireless channels in a forwarding communication network, said method comprising:
a) coupling a hub access-point (HAP) device of said communication network to a parent network;
b) configuring N−1 forwarding access-point (FAP) devices, where N is a positive integer greater than 1, wherein for M=M_{MIN}=1 to M=M_{MAX}=(N−1) each M^{th} FAP device is configured to engage in inward communication over an M^{th} wireless channel and to engage in connectionless outward communication over an (M+1)^{th} wireless channel;
c) configuring said HAP device to engage in outward communication over said M_{MIN}^{th} wireless channel;
d) configuring a customer-premise-equipment (CPE) device to engage in inward communication over said M_{MAX}^{th} wireless channel;
e) establishing a hub-user communication link having N hops between said HAP device and said CPE device through N−1 sequential ones of said FAP devices; and
f) executing said outward and inward communications over said hub-user communication link.

28. A method as claimed in claim 27 wherein, prior to said configuring activity b), said method additionally comprises:
analyzing said communication network to determine potential paths for said hub-user communication link;
determining which of said potential paths is an optimal path for said hub-user communication link;
ascertaining a number of hops in said optimal path; and
setting N equal to said number of hops.

29. A method as claimed in claim 27 wherein conjoined ones of said N wireless channels have different frequencies.

30. A method as claimed in claim 27 wherein:
said method additionally comprises determining channel interference ranges of said HAP device, each of said N−1 FAP devices, and said CPE device; and
said configuring activity b), for said each M^{th} FAP device of said N−1 FAP devices, comprises:
noting frequencies of wireless channels of already-configured ones of said N−1 FAP devices residing in said interference ranges of said HAP device, each of said N−1 FAP devices, and said CPE device in which said each M^{th} FAP device resides;
assigning said M^{th} wireless channel of said M^{th} FAP device at a frequency different from said frequencies noted by said noting activity; and
assigning said (M+1)^{th} wireless channel of said M^{th} FAP device at a frequency different said frequency of said M^{th} wireless channel of said M^{th} FAP device and different from said frequencies noted by said noting activity.

31. A method as claimed in claim 27 wherein, for said each M^{th} FAP device of said N−1 FAP devices, said configuring activity b) comprises assigning said M^{th} and (M+1)^{th} wireless channels at frequencies in an unlicensed portion of the radio spectrum.

32. A forwarding communication network for providing communication throughout a region, said communication network comprising:
a hub access-point (HAP) device coupled to a parent network and configured to engage in connectionless outward communication within a range of said HAP device over a first wireless channel, said range of said HAP device being a portion of said region;
a plurality of forwarding access-point (FAP) devices, wherein each FAP device in said plurality of FAP devices is configured to engage in connectionless inward communication and connectionless outward communication within a range of said each FAP device, each of said ranges of said FAP device being a portion of said region, and wherein one FAP device in said plurality of FAP devices is positioned within said range of said HAP device and configured to engage in said connectionless inward communication with said HAP device over said first wireless channel; and
a plurality of customer-premise-equipment (CPE) devices positioned outside of said range of said HAP device, wherein each CPE device in said plurality of CPE devices is positioned within said range of said one FAP device and configured to engage in connectionless inward communication with said one FAP device over a second wireless channel.

33. A forwarding communication network as claimed in claim 32 wherein:
said first wireless channel is provided at a first frequency; and
said second wireless channel is provided at a second frequency different from said first frequency.

34. A forwarding communication network as claimed in claim 32 wherein:
said HAP device is configured to engage in said connectionless outward communication with a first FAP device in said plurality of FAP devices over said first wireless channel, wherein said first FAP device is located within said range of said HAP device;
said first FAP device is configured to engage in said connectionless inward communication with said HAP device over said first wireless channel;
said first FAP device is additionally configured to engage in said connectionless outward communication with a second FAP device in said plurality of FAP devices over a third wireless channel, wherein said second FAP device is located within a range of said first FAP device;
said second FAP device is configured to engage in said connectionless inward communication with said first FAP device over said third wireless channel;
said second FAP device is additionally configured to engage in said connectionless outward communication with one CPE device in said plurality of CPE devices over said second wireless channel, wherein said one CPE device is located within a range of said second FAP device; and
said one CPE device is configured to engage in said connectionless inward communication with said second FAP device over said second wireless channel.

35. A forwarding communication network as claimed in claim 32 wherein:
said HAP device utilizes a substantially non-directional antenna to effect said connectionless outward communication;
each FAP device in said plurality of FAP devices utilizes a directional antenna to effect said connectionless inward communication;
each FAP device in said plurality of FAP devices utilizes a substantially non-directional antenna to effect said connectionless outward communication; and
each CPE device in said plurality of CPE devices utilizes a substantially non-directional antenna to effect said connectionless inward communication.

36. A forwarding communication network as claimed in claim 35 wherein said directional antenna of said each FAP device is substantially aimed at an antenna of one of said HAP device and another FAP device in said plurality of FAP devices.

37. A forwarding communication network as claimed in claim 32 wherein:
said HAP device is a first HAP device configured to engage in connectionless outward communication within a first range of said HAP device, said first range of said HAP device being a portion of said region;
said communication network additionally comprises a second HAP device coupled to said parent network and configured to engage in connectionless outward communication within a second range of said HAP device, said second range of said HAP device being a portion of said region; and
one FAP device in said plurality of FAP devices is positioned within said second range of said HAP device and configured to engage in said connectionless inward communication with said second HAP device.

38. A forwarding communication network as claimed in claim 37 wherein:
said first HAP device is configured to engage in connectionless outward communication over said first wireless channel having a first frequency;
said second HAP device is configured to engage in connectionless outward communication over a third wireless channel having a third frequency different from said first frequency; and
said one FAP device positioned within said second range of said HAP device is configured to engage in said connectionless inward communication with said second HAP device over said third wireless channel.

39. A forwarding communication network as claimed in claim 37 additionally comprising:
a first hub-user communication link of N hops, where N is a positive integer greater than 1, wherein said first hub-user communication link couples said first HAP device to one of said CPE devices through N−1 sequential ones of said FAP devices;
a second hub-user communication link of L hops, where L is a positive integer greater than 1, wherein said second hub-user communication link couples said second HAP device to said one CPE device through L−1 sequential ones of said FAP devices; and
each of said hops in said first and second hub-user communication links is effected over a wireless channel having a frequency different from frequencies of wireless channels of conjoined ones of said hops.
